(19) United States
(12) Patent Application Publication
(10) Pub. No.: US 2013/0266474 A1
(43) Pub. Date: Oct. 10, 2013

(54) METHOD FOR PRODUCING MAGNETIC GREEN COMPACTS, MAGNETIC GREEN COMPACT, AND SINTERED BODY

(71) Applicants: Toru Maeda, Itami-shi (JP); Takeshi Kato, Osaka-shi (JP)

(72) Inventors: Toru Maeda, Itami-shi (JP); Takeshi Kato, Osaka-shi (JP)

(73) Assignee: SUMITOMO ELECTRIC INDUSTRIES, LTD., Osaka-shi, Osaka (JP)

(21) Appl. No.: 13/995,342

(22) PCT Filed: Aug. 9, 2012
(86) PCT No.: PCT/JP2012/070316

§ 371 Date: Jun. 18, 2013

(30) Foreign Application Priority Data
Aug. 22, 2011 (JP) 2011-180978
Jun. 1, 2012 (JP) 2012-126437

(51) Int. Cl. B22F 3/24; H01F 1/01

(52) U.S. Cl. CPC B22F 3/24; H01F 1/01
USPC 419/66; 75/228

(57) ABSTRACT

A method is provided for producing magnetic green compacts. Material powder including a rare earth alloy and containing not less than 15 mass % of fine particles with particle diameter of not more than 2 μm is filled into a compacting mold, then compacted and compressed, and subjected to magnetic fields to give a green compact. A powder compact having a packing density 1.05 to 1.2 times the bulk density is subjected to a weak magnetic field of 1 to 2 T to give a compact. The magnetic field strength is increased to not less than 3 T at an excitation rate of 0.01 to 0.15 T/sec, and the strong magnetic field of not less than 3 T is applied to the compact by a high-temperature superconducting coil. The magnetic field is applied by the high-temperature superconducting coil in a direction opposite to a direction applied by a normal conducting coil.

### TECHNICAL FIELD

The present invention relates to a magnetic green compact production method for producing green compacts as materials for sintered magnets used as, for example, permanent magnets, to a magnetic green compact, and to a sintered body. In particular, the invention relates to a method for producing magnetic green compacts which can produce with good productivity green compacts capable of forming rare earth magnets with excellent magnetic properties.

### BACKGROUND ART

Rare earth magnets (typically Nd—Fe—B magnets and Sm—Fe—N magnets) have been widely used as permanent magnets in devices such as motors and power generators. Rare earth magnets are classified into sintered magnets produced utilizing powder metallurgy, and bond magnets including a mixture of material powder and a binder resin. Sintered magnets have a higher proportion of magnetic phase and exhibit better magnetic properties compared to bond magnets containing a binder resin.

Sintered magnets are typically obtained by compacting material powder under the application of a magnetic field, and sintering the compact (for example, Patent Literature 1). The magnetic field applied during compacting enhances the orientation of crystals, thus improving magnetic properties.

### CITATION LIST

### Patent Literature

PTL 1: Japanese Unexamined Patent Application Publication No. 06-224018

### SUMMARY OF INVENTION

### Technical Problem

Demands have been placed on further improvements in the magnetic properties of rare earth sintered magnets. Further, producing high-performance rare earth sintered magnets with high productivity is desirable.

Enhancing orientation is effective for improving magnetic properties. However, further enhancements in orientation are difficult to attain with conventional production methods.

For example, such difficulties are encountered when material powder contains fine particles with diameters of 2 μm or below (hereinafter, referred to as fine powder), namely, when powder having a particle size distribution is used. Upon the application of an external magnetic field, coarse particles are relatively susceptible to the magnetic field and are rotated to achieve sufficient orientation. However, fine particles are relatively insusceptible to the magnetic field due to their large specific surface area and consequent strong demagnetizing field. Thus, the application of an external magnetic field cannot cause these particles to be rotated sufficiently, resulting in insufficient orientation. As a result, the degree of crystal orientation of green compacts obtained from fine material powder is limited to about 80% at best.

The rotation of fine particles is facilitated by increasing the magnitude of a magnetic field applied. However, a magnetic field with a magnitude enough for fine particles to be rotated sufficiently is difficult to generate by external excitation using general electromagnets (for example, solenoid, pulse and the like) or permanent magnets. That is, the use of such a magnitude is unsuitable for mass production. Thus, an attempt to enhance orientation by increasing the magnitude of a magnetic field results in a decrease in industrial productivity. Therefore, it has been a conventional practice to use material powder consisting of relatively coarse particles by removing such fine particles which are difficult to orientate. When powder consists of coarse particles 100, the particles 100 possibly having a random crystal orientation as illustrated in FIG. 3(A) before the application of a magnetic field can be oriented in a desired direction by applying a magnetic field as illustrated in FIG. 3(B). However, the removal of fine particles leads to a deterioration in yield and further to a decrease in productivity.

It is therefore an object of the present invention to provide a method for producing magnetic green compacts capable of forming rare earth sintered magnets with excellent magnetic properties. It is another object of the invention to provide a magnetic green compact capable of forming a rare earth sintered magnet with excellent magnetic properties, and to provide a sintered body.

### Solution to Problem

Fine particles themselves are hardly rotated by a magnetic field. However, when fine particles are surrounded by particles and even if the size of such particles is approximately similar to that of fine particles, the rotation of a collection of such particles produces a moment that acts on the respective fine particles to allow these fine particles to be rotated. It is therefore necessary that particles present around fine particles be rotated reliably as well as that fine particles be rotated simultaneously with the rotation of these surrounding particles. In controlling the orientation in this manner, the present invention proposes that a magnetic field be applied at least two times each in a different direction, and that at least one application of a magnetic field be performed using a superconducting coil.

A method for producing magnetic green compacts according to the present invention produces green compacts as materials for sintered magnets using powder including a rare earth alloy containing a rare earth and iron, the method including the following preparation step and compacting step. The compacting step includes the following light compacting step, weak magnetic field application step and strong magnetic field application step.

Preparation step: A step of providing material powder including the rare earth alloy and containing 15 mass % to 100 mass % of fine particles with a particle diameter of not more than 2 μm.

Compacting step: A step of filling the material powder into a compacting mold, compacting and compressing the material powder, and applying a magnetic field to form a green compact.

Light compacting step: A step of compacting and compressing the material powder filled in the compacting mold to fabricate a powder compact having a packing density that is 1.05 to 1.2 times the bulk density.

Weak magnetic field application step: A step of applying a weak magnetic field of 1 T to 2 T to the powder compact.

Strong magnetic field application step: A step of increasing the magnetic field strength to not less than 3 T at an excitation rate of 0.01 T/sec to 0.15 T/sec, and applying the strong magnetic field of not less than 3 T to the compact having undergone the weak magnetic field application step.

The weak magnetic field is applied in a direction at a solid angle of 90° to 180° to a desired direction in which crystals of particles forming the green compact are to be oriented. The strong magnetic field is applied in the desired orientation direction using a superconducting coil.

A highly oriented magnetic green compact of the invention is obtained by the inventive method for producing magnetic green compacts. The magnetic green compact of the invention is a green compact for use as a material for sintered magnets, and is formed of powder including a rare earth alloy containing a rare earth and iron. The powder contains 15 mass % to 100 mass % of fine particles with a particle diameter of not more than 2 μm. The green compact has a degree of crystal orientation of not less than 95%.

According to the method for producing magnetic green compacts of the present invention, fine powder containing fine particles described above is used as the material powder, and a magnetic field with the specific magnitude is applied several times in the specific directions. In particular, the specific excitation rate is adopted in applying a strong magnetic field. By these configurations, green compacts having a high degree of crystal orientation (typically magnetic green compacts of the invention) are obtained. Further, the use of fine powder as the material powder is advantageous in that powder, for example, as-crushed powder, namely, powder which has a particle size distribution including fine particles can be used as such. The invention thus eliminates the need of removing fine particles in contrast to conventional methods. Considering these points, the inventive method for producing magnetic green compacts can produce excellently oriented green compacts with good productivity. Further, the obtained green compacts may be used as materials to form rare earth sintered magnets having excellent magnetic properties. Thus, the inventive method for producing magnetic green compacts can contribute to increasing the productivity of rare earth sintered magnets exhibiting excellent magnetic properties.

Nd—Fe—B magnets are rare earth sintered magnets exhibiting the best properties. Dysprosium (Dy) having a great effect of increasing coercive force is usually added to such magnets. Because Dy is a scarce resource, however, it has been desired that coercive force be increased without adding Dy or with a smaller amount of Dy used. According to the method for producing magnetic green compacts of the present invention, the use of fine powder having a particle diameter of 2 μm in the material powder makes it possible to reduce the size of crystal grain boundaries when the green compacts are sintered. Thus, an increase in coercive force is expected without the addition of Dy. Accordingly, also from the viewpoint of coping with the Dy resource problem, the method for producing magnetic green compacts of the present invention is expected to contribute to increasing the productivity of sintered magnets exhibiting excellent magnetic properties.

Because the magnetic green compacts of the invention have excellent orientation, they may be used as materials for sintered magnets to give rare earth sintered magnets exhibiting excellent magnetic properties. Further, sintered bodies of the invention obtained by sintering the inventive magnetic green compacts may be suitably used as rare earth sintered magnets that exhibit excellent magnetic properties due to the excellent orientation of the inventive green compacts used as materials.

In one embodiment of the invention, the strong magnetic field application step may be performed in such a manner that the magnetic field strength is increased to not less than 3 T at an excitation rate of 0.01 T/sec to 0.15 T/sec and, after the strength reaches 3 T or above, the compact having undergone the weak magnetic field application step is further compacted and compressed under the application of the strong magnetic field of not less than 3 T so as to increase the packing density to above 1.2 times the bulk density.

According to the above embodiment, the obtainable green compacts achieve higher strength and improved handling properties because the compacts are denser as a result of the further compacting and compression under the application of a strong magnetic field.

In one embodiment of the invention, the strong magnetic field application step may be performed in such a manner that the magnetic field strength is increased to not less than 3 T at an excitation rate of 0.01 T/sec to 0.15 T/sec and, after the strength reaches 3 T or above, the compact having undergone the weak magnetic field application step is further compacted and compressed under the application of the strong magnetic field of not less than 3 T so as to increase the packing density to above 1.2 and not more than 1.45 times the bulk density, and further the magnetic field strength is increased to not less than 5 T at an excitation rate of 0.01 T/sec to 0.15 T/sec and, after the strength reaches 5 T or above, the compact is further compacted and compressed under the application of the strong magnetic field of not less than 5 T so as to obtain a packing density that is not less than 1.45 times the bulk density and not more than 66% the true density.

According to the above embodiment, the obtainable green compacts achieve still higher orientation and further improved strength because the compacts are denser and improved in orientation as a result of the compacting and compression under the application of a strong magnetic field and the subsequent compacting and compression under the application of a stronger magnetic field. Controlling the final degree of compression in the above specific range prevents particles from being cracked and also suppresses a decrease in magnetic properties due to cracks.

In one embodiment of the invention, the superconducting coil may be a high-temperature superconducting coil.

High-temperature superconducting coils are capable of: (1) high excitation rate (not less than 0.01 T/sec, further not less than 0.1 T/sec), (2) applying a strong magnetic field (not less than 3 T, further not less than 5 T), and (3) applying a magnetic field over a large area. In contrast to normal conducting pulse coils having a limited area for magnetic field application, the above embodiment may be utilized for the production of green compacts of any sizes usable as materials for permanent magnets, and may enhance orientation stably even with a high content of fine particles, thus achieving great industrial significance.

### Advantageous Effects of Invention

The method for producing magnetic green compacts of the present invention can produce excellently oriented magnetic green compacts with high productivity. The inventive magnetic green compacts and sintered bodies have a high degree of crystal orientation and can give rare earth sintered magnets exhibiting excellent magnetic properties.

### BRIEF DESCRIPTION OF DRAWINGS

FIG. 1 is a schematic view illustrating an arrangement of a compacting mold and coils for applying a magnetic field in a method for producing magnetic green compacts of the present invention.

FIG. 2 is a schematic view illustrating orientations of particles in a method for producing magnetic green compacts of the present invention.

FIG. 3 is a schematic view illustrating orientations of particles.

### DESCRIPTION OF EMBODIMENTS

Hereinbelow, the present invention will be described in detail.

### [Production Method]

### [Preparation Step]

Powder including a rare earth alloy is provided as material powder. Examples of the rare earth alloys include RE-Fe—X alloys and RE-Fe-ME-X alloys wherein RE=at least one selected from Y, La, Ce, Pr, Nd, Dy, Tb and Sm, X=one selected from B, C and N, and ME=at least one selected from Co, Cu, Mn and Ni. Specific examples include Nd—Fe—B alloy, Nd—Fe—C alloy, Sm—Fe—N alloy and Nd—Fe—Co—B alloy. The material powder may be any of known rare earth alloy powders used for rare earth sintered magnets.

The material powder may be produced by crushing a melt cast ingot or a rapidly-solidified foil of an alloy having a desired composition with a crushing machine such as a jaw crusher, a jet mill or a ball mill, or may be produced by atomization such as gas atomization. Alternatively, powder obtained by a known powder production method, or atomized powder may be further crushed for use as the material powder. The particle size distribution of the material powder, and the shapes of particles forming the powder may be controlled by appropriately changing crushing conditions and production conditions. The shapes of particles are not particularly limited. However, the closer to sphere the particles, the easier the densification and the more easily the particles are rotated by the application of a magnetic field. Powder having high sphericity may be obtained by atomization.

One of the features of the material powder is that the material powder contains fine particles with a particle diameter of not more than 2 μm. The particle sizes of the material powder are values measured with a laser diffraction particle size distribution analyzer. The material powder may consist substantially solely of fine particles with a particle diameter of not more than 2 μm (the content of such fine particles in the material powder: 100 mass %). In the method for producing magnetic green compacts of the present invention, a magnetic field with a specific magnitude is applied several times in specific directions, and the magnetic field strength is increased at a specific high excitation rate. According to this configuration, even when powder containing much finer particles (for example, not more than 1 μm) than conventional sizes is used as the material powder, the obtainable green compacts achieve an orientation that is comparable to or higher than that of green compacts obtained by a conventional production method utilizing coarse powder. Such green compacts as materials can give rare earth sintered magnets exhibiting magnetic properties comparable to or higher than those of sintered magnets from green compacts obtained by a conventional production method.

Because a high packing density can be obtained more easily as particles are finer, the maximum particle diameter of the material powder is preferably not more than 20 μm, and more preferably not more than 15 μm.

The larger the proportion of particles exceeding 2 μm in the material powder, the more easily the particles are oriented. As the proportion of particles with diameters of not more than 2 μm increases, the material powder is densified more easily and the productivity is improved because the amount to be removed by classification after crushing can be reduced easily or because the material powder can be used without any removal of particular particles. In view of productivity, the content of particles with diameters of not more than 2 μm is preferably not less than 25 mass %, more preferably not less than 35 mass %, and particularly preferably not less than 50 mass % relative to the material powder.

A lubricant may be added to the material powder. When mixed with a lubricant, the particles forming the material powder are rotated easily upon the application of a magnetic field. Thus, a lubricant facilitates increasing the orientation. Various materials in any forms (liquid, solid) may be used as lubricants provided that they do not substantially react with the material powder. Examples of the liquid lubricants include ethanol, machine oils, silicone oils and castor oil. Examples of the solid lubricants include metal salts such as zinc stearate, hexagonal boron nitride and waxes. The amount of liquid lubricant added may be about 0.01 mass % to 10 mass % relative to 100 g of the material powder. The amount of solid lubricant added may be about 0.01 mass % to 5 mass % relative to the mass of the material powder.

### [Compacting Step]

### (Light Compacting Step)

A compacting mold with a desired shape and size is provided in order to obtain green compacts with the desired shape and size. The compacting mold may be any of molds usually utilized in the production of green compacts as materials for sintered magnets, and typically has a die, and upper and lower punches. Alternatively, a cold isostatic press may be used.

In the light compacting step, the material powder is compacted and compressed to a certain degree of unity into a powder compact to such an extent that gaps are present between particles so that relatively coarse particles exceeding 2 μm, in particular with diameters of 5 μm or more, can be sufficiently rotated in the subsequent weak magnetic field application step. In detail, the material powder is compressed such that the powder compact obtained by this compacting and compression has a packing density that is 1.05 to 1.2 times the bulk density. The bulk density is defined as an apparent density (the mass of the material powder filled into a compacting mold/the volume of the compacting section of the compacting mold before compacting and compression) immediately before the material powder is compacted and compressed. The packing density is defined as an apparent density (the mass of the material powder filled into the compacting mold/the volume of the compacting section of the compacting mold after compacting and compression (=the volume of the powder compact) after the material powder is compacted and compressed.

The compacting pressure during compacting may be selected appropriately in accordance with, for example, the packing density. For example, the compacting pressure may be 0.05 ton/cm² to 0.5 ton/cm². In the case where compacting and compression are performed in multistages as will be described later, the compacting pressure during each compacting may be selected appropriately in accordance with factors such as the packing density.

### (Weak Magnetic Field Application Step)

A magnetic field is applied to the powder compact. This magnetic field is applied with a relatively low strength (1 T to 2 T). Further, the magnetic field is applied not in a direction in which crystals of particles forming the final green compact are to be oriented, but in a direction at a solid angle of 90° to 180° to the desired orientation direction. That is, one of the features of the inventive method for producing magnetic green compacts is that the method includes a step of applying a magnetic field in a direction different from the direction in which orientation is desired to take place. In the case where the particles forming the powder compact have a particle size distribution or when such particles are the fine particles described above, one application of a magnetic field will not align all the particles in the same direction and will allow only part of the particles to be rotated sufficiently. A possible approach is thus to apply a magnetic field several times instead of one time. However, as already described, fine particles are difficult to rotate by the application of a magnetic field as compared to coarse particles. Even if a magnetic field is applied several times in the same direction, the particles that have been rotated by the first application of a magnetic field are no longer substantially rotated by the subsequent applications of a magnetic field. As a result, fine particles are not allowed to be rotated sufficiently. Thus, the inventive method for producing magnetic green compacts avoids repeating the application of a magnetic field in the same direction and instead applies a magnetic field at least two times in different directions. Of the two applications, the first application is performed in a direction different from the direction in which orientation is desired to take place. In this manner, the particles that have been rotated by the first application of a magnetic field are directed to a direction different from the direction in which orientation is desired, and therefore have a chance to be rotated by the second application of a magnetic field. As a result, an increased number of particles are rotated by the second application of a magnetic field. That is, the above configuration allows for the rotation of coarse particles present around fine particles as well as the rotation of a collection of particles including coarse particles and small particles with sizes approximately similar to those of fine particles that have not been rotated by the first application of a magnetic field. Thus, fine particles are allowed to be rotated easily in a direction in which orientation is desired to take place.

As mentioned above, the application of a magnetic field in the weak magnetic field application step is an operation mainly intended to allow more particles to be rotated when subjected to the second application of a magnetic field. Thus, this application is not an operation for rotating the particles in a direction in which orientation is desired. The weak magnetic field application step is mainly intended to rotate particles having sizes exceeding 2 μm, further 3 μm or more, and particularly 5 μm or more. Thus, the strength of the magnetic field may be relatively low, for example 1T to 2 T.

Even when the material powder contains a large amount of 2 μm or finer particles, for example, even when the material powder is fine powder consisting substantially solely of fine particles, such powder will contain particles that are rotatable by a 1 T to 2 T magnetic field and thus will achieve a state in which a large number of particles will exhibit a large angle of rotation when subjected to the second application of a magnetic field. A rotation occurring at a larger angle produces a larger amount of momentum and is therefore insusceptible to influences of friction or the like interfering with the rotation. According to the above configuration in which particles are oriented by repeating magnetic excitation several times in the specific different directions, even material powder containing a large proportion of fine particles can give green compacts having higher orientation than obtained when particles are oriented by one magnetic excitation or by repeating magnetic excitation several times in the same direction.

For the application of a magnetic field in the weak magnetic field application step, any of magnets capable of applying a magnetic field with a strength of 1 T to 2 T may be used, with specific examples including normal conducting magnets with normal conducting coils such as copper wire coils, and superconducting magnets with superconducting coils.

### (Strong Magnetic Field Application Step)

The strong magnetic field application step is mainly intended to increase the orientation of the compact having undergone the weak magnetic field application step. (Hereinafter, this compact will be referred to as the pre-compact.) In this step, a magnetic field is applied in a direction in which crystals of particles forming the final green compact are to be oriented. In particular, one of the features of this step is that high-speed excitation is performed at an excitation rate of not less than 0.01 T/sec and a strong magnetic field with a strength of not less than 3 T is applied. Even in the case where the material powder is a rough mixture containing fine particles, the high-speed excitation allows fine particles to be rotated simultaneously when coarse particles susceptible to a magnetic field are rotated. That is, the particles forming the pre-compact can be rotated together at the same time. If the excitation rate is less than 0.01 T/sec, there are risks that only coarse particles are rotated when the strength of the magnetic field reaches about 1 T to 2 T as well as that the rotation of such coarse particles has stopped when the strength reaches 3 T. Because the particles around fine particles are not substantially rotated even under the application of such a strong magnetic field of 3 T or more, there is no moment of such surrounding particles helping the rotation of fine particles. Thus, the rotation of fine particles becomes insufficient and the orientation cannot be enhanced. A higher excitation rate tends to allow more particles forming the pre-compact to be rotated simultaneously. Thus, the excitation rate is preferably not less than 0.05 T/sec, and more preferably not less than 0.1 T/sec. On the other hand, an excessively high excitation rate as encountered in pulse excitation causes a risk that enhancing the orientation may become difficult due to the particles being overrotated. Thus, the excitation rate is limited to be not more than 0.15 T/sec. Excitation at a rate of not more than 0.15 T/sec ensures that particles are rotated stably and green compacts having high orientation are obtained favorably.

The orientation can be enhanced to a higher level as a stronger magnetic field is applied in the strong magnetic field application step. Thus, the magnitude of the magnetic field applied is more preferably not less than 5 T.

Normal conducting magnets may be used in performing the high-speed excitation as well as in applying the strong magnetic field. Alternatively, superconducting magnets, in particular high-temperature superconducting magnets may be suitably used. Low-temperature superconducting magnets usually require about 5 minutes to 10 minutes to change the strength by 1 T, and the excitation rate is less than 0.01 T/sec. In contrast, high-temperature superconducting magnets can achieve, for example, a 1 T change within 10 seconds. That is, an excitation rate of not less than 0.1 T/sec is feasible. In addition, a strong magnetic field of not less than 3 T, and further not less than 5 T can be generated easily. Further, high-temperature superconducting magnets are capable of an excitation rate of not more than 0.1 T/sec, for example 0.01 T/sec or above, and thus allow for low-speed excitation as well as high-speed excitation. Furthermore, high-temperature superconducting magnets produce a larger magnetic field than do normal conducting magnets. Thus, a strong magnetic field can be applied to a wide space. For this reason, high-temperature superconducting magnets can be utilized for the production of small green compacts as well as large green compacts, allowing a high degree of freedom in the size of objects to be subjected to the magnetic field. Further, the capability of changing the magnetic field strength at high speed enables quick control of the application of a magnetic field. In addition, high-temperature superconducting magnets have further advantages; for example, high-temperature superconducting magnets can generate a strong magnetic field for a longer time than do normal conducting pulse coils, can rotate the material powder even by a relatively low magnetic field strength, and allow other treatments such as compacting and vacuum dewaxing (in which lubricants that have been liquefied or evaporated by heating are removed by vacuum suction) to be carried out concurrently with the application of a magnetic field. Further, the use of high-temperature superconducting magnets often makes it possible to reduce the amount of lubricants used or eliminate the use of lubricants. Typically, high-temperature superconducting magnets are operated while superconducting coils of an oxide superconductor are cooled by conduction cooling with a refrigerating machine (operation temperature: about −260° C. or above).

In the strong magnetic field application step, a magnetic field is applied in a direction in which crystals of particles forming the final green compact are to be oriented. That is, one of the features of the inventive method for producing magnetic green compacts is that the method includes a step of applying a magnetic field in a direction different from that in the weak magnetic field application step, thus enhancing orientation. In detail, a magnetic field is applied in the weak magnetic field application step in a direction different from (typically opposite to) the direction in which orientation is desired to take place, and thereafter a magnetic field is applied again in the direction in which orientation is desired, in particular a strong magnetic field excited at the aforementioned high speed is applied in such a direction. According to this configuration, even fine particles that are possibly present in the material powder can be rotated sufficiently and stably, resulting in green compacts having high orientation.

By applying a magnetic field to the pre-compacts from the weak magnetic field application step under the above specific conditions (excitation rate, magnetic field magnitude, magnetic field direction), green compacts having a packing density that is not more than 1.2 times the bulk density can be obtained. (Such green compacts represent one embodiment of the inventive green compacts.)

In particular, dense green compacts can be obtained by carrying out the strong magnetic field application step in such a manner that the magnetic field strength is increased to not less than 3 T at an excitation rate of 0.01 T/sec to 0.15 T/sec and, after the strength reaches 3 T or above, the pre-compact is further compacted and compressed under the application of the strong magnetic field of not less than 3 T. (Hereinafter, this compacting will be referred to as first densification compacting.) In detail, green compacts exhibiting higher strength due to densification can be obtained by compacting and compressing the pre-compacts to increase the packing density to above 1.2 times the bulk density. (Such green compacts having a packing density that is above 1.2 times the bulk density represent one embodiment of the inventive green compacts.) According to this embodiment, the pre-compact is subjected to compacting and compression after the magnetic field strength reaches 3 T or above. Thus, particles can be rotated sufficiently to achieve high orientation during the excitation. Further, because the pre-compact is compacted and compressed under the application of a magnetic field of not less than 3 T in the above embodiment, the particles are unlikely to decrease their orientation during compacting, and the fine particles are rotated sufficiently and stably by the application of the strong magnetic field, thus achieving still higher orientation. As a result, the above embodiment ensures that the obtainable green compacts are denser and have a higher degree of crystal orientation. In this embodiment, higher orientation tends to be obtained as the magnetic field strength is higher at the initiation of compacting and compression of the pre-compacts. Thus, the magnetic field strength is more preferably not less than 5 T.

Further, in order to obtain denser compacts, a configuration may be adopted in which the first densification compacting is performed such that the packing density becomes above 1.2 and not more than 1.45 times the bulk density, thereafter the magnetic field strength is increased to not less than 5 T at an excitation rate of 0.01 T/sec to 0.15 T/sec and, after the strength reaches 5 T or above, the compact having undergone the first densification compacting (hereinafter, this compact will be referred to as the densified compact) is further compacted under the application of the strong magnetic field of not less than 5 T so as to obtain a packing density that is not less than 1.45 times the bulk density and is not more than 66% the true density. (Hereinafter, this compacting will be referred to as second densification compacting.) Similarly in the second densification compacting, the excitation at the specific high rate ensures that a decrease in orientation is suppressed from occurring during the excitation as well as that the fine particles in the densified compact achieve further enhanced orientation, and further densification becomes possible. According to the above embodiment, green compacts having a packing density that is not less than 1.45 times the bulk density and is not more than 66% the true density are obtained. (Such green compacts represent one embodiment of the inventive green compacts.) By performing the second densification compacting such that the packing density becomes not more than 66% the true density, the particles are suppressed from being cracked during the compacting. Because a decrease in magnetic properties due to cracks is suppressed, such green compacts as materials can give rare earth sintered magnets exhibiting excellent magnetic properties. In this embodiment, higher orientation tends to be obtained as the magnetic field strength is higher at the initiation of compacting and compression of the densified compacts. Thus, the magnetic field strength is more preferably not less than 5.5 T. However, a long excitation time is required to excite the magnetic field to an excessively high strength. Thus, the magnetic field strength is preferably not more than 10 T, and more preferably not more than 8 T. In both the first densification compacting and the second densification compacting, the excitation rate is more preferably not less than 0.1 T/sec.

Superconducting magnets such as high-temperature superconducting magnets can produce both of the weak and strong magnetic fields described above. Accordingly, the application of both weak and strong magnetic fields is feasible with one superconducting magnet. When one superconducting magnet is used, however, the magnetic field produced in the weak magnetic field application step needs to be demagnetized once and be thereafter excited again because the excitation in the strong magnetic field application step needs to take place at a high rate. That is, a certain amount of time is necessary for demagnetization. In contrast, the production time can be shortened by using a separate magnet in the weak magnetic field application step and a separate superconducting magnet in the strong magnetic field application step. This allows the high-speed excitation to be performed with the superconducting magnet irrespective of the presence or absence of the magnetic field produced by the magnet in the weak magnetic field application step. When a weak magnetic field is present at the initiation of the excitation with a superconducting magnet, the magnitude of the magnetic field produced by the superconducting magnet may be controlled so as to cancel the weak magnetic field. In this case, however, extra energy is required for the canceling. Thus, it is preferable that the generation of a weak magnetic field be discontinued immediately after the start of excitation of a superconducting magnet for the production of a strong magnetic field.

### [Green Compacts]

A magnetic green compact of the present invention contains fine particles having a particle diameter of not more than 2 μm. The content of fine particles may vary depending on the material powder. For example, the content of fine particles may be not less than 25 mass % in an embodiment, particularly not less than 35 mass % in another embodiment, and not less than 50 mass % in a further embodiment.

The magnetic green compact of the invention has a very high degree of crystal orientation. In an embodiment, the magnetic green compact satisfies a degree of crystal orientation of not less than 95%, and in a further embodiment not less than 97%. The degree of crystal orientation may be measured by a method described later.

The size and material of particles forming the inventive magnetic green compact are substantially unchanged from the size and material of the material powder. To determine the size of particles forming the green compact, for example, the surface or a cross section of the green compact is microscopically observed to extract profiles of particles from the observed image, then the areas of the extracted profiles are calculated, and, assuming that the calculated areas are those of circles, the diameters of the circles are determined to give the particle diameters of the particles. This calculation of particle diameters may be performed easily by utilizing a commercial image processor. The composition of particles forming the green compact may be identified by, for example, X-ray diffractometry.

### [Sintered Bodies]

A sintered body of the present invention may be obtained by sintering the inventive magnetic green compact. For example, sintering conditions may be temperature: 1000° C. to 1200° C., holding time: 0.5 hours to 3 hours, and atmosphere: vacuum, argon or the like. After sintering, a heat treatment (for example, aging treatment) may be appropriately carried out in order to condition magnetic properties. Heat treatment conditions may be temperature: 500° C. to 800° C., holding time: 1 hour to 10 hours, and atmosphere: vacuum, argon or the like. The obtained sintered body may be suitably used as a rare earth sintered magnet, typically a permanent magnet.

### TEST EXAMPLES

Hereinbelow, embodiments of the invention will be described in greater detail by presenting test examples.

In the tests, material powders were provided which included a rare earth-iron-boron alloy and had various particle size distributions. The material powders were compacted into green compacts through a light compacting step→a weak magnetic field application step→a strong magnetic field application step. The obtained green compacts were analyzed to determine the orientation. Further, the green compacts were sintered, and the sintered bodies were analyzed to determine the orientation and magnetic properties.

### [Material Powders]

A melt cast ingot of Nd_{2.2}FeB alloy was provided. The ingot was subjected to a solution treatment at 1100° C. for 10 hours and was thereafter crushed with a ball mill to give material powder. Several kinds of material powders having different particle size distributions were prepared by altering the crushing time. The particle size distributions were measured with a commercial laser diffraction particle size distribution analyzer. Table I describes the particle size distributions of the material powders, and the contents of 2 μm or finer particles (mass %). The material powders were substantially free from particles exceeding 15 μm in diameter. Each of the material powders was combined with 0.8 mass % of zinc stearate (lubricant).

TABLE I

| | Particle size distribution (mass %) | | | | | | Content of 2 μm |
|---|---|---|---|---|---|---|---|
| Sample | 0.1 μm ≦ par- | 1 μm < par- | 2 μm < par- | 3 μm < par- | 5 μm < par- | 8 μm < par- | or finer particles |
| No. | ticles ≦ 1 μm | ticles ≦ 2 μm | ticles ≦ 3 μm | ticles ≦ 5 μm | ticles ≦ 8 μm | ticles ≦ 15 μm | (mass %) |
| 1 | 34 | 38 | 27 | 1 | 0 | 0 | 72 |
| 2 | 31 | 33 | 25 | 11 | 0 | 0 | 64 |
| 3 | 22 | 23 | 24 | 24 | 5 | 2 | 45 |
| 4 | 8 | 10 | 19 | 38 | 19 | 6 | 18 |
| 5 | 6 | 9 | 10 | 46 | 22 | 7 | 15 |
| 6 | 2 | 3 | 7 | 43 | 36 | 9 | 5 |
| 7 | 0 | 0 | 2 | 41 | 46 | 11 | 0 |
| 8 to 36 | 31 | 33 | 25 | 11 | 0 | 0 | 64 |

### [Compacting Mold and Magnets for Magnetic Field Application]

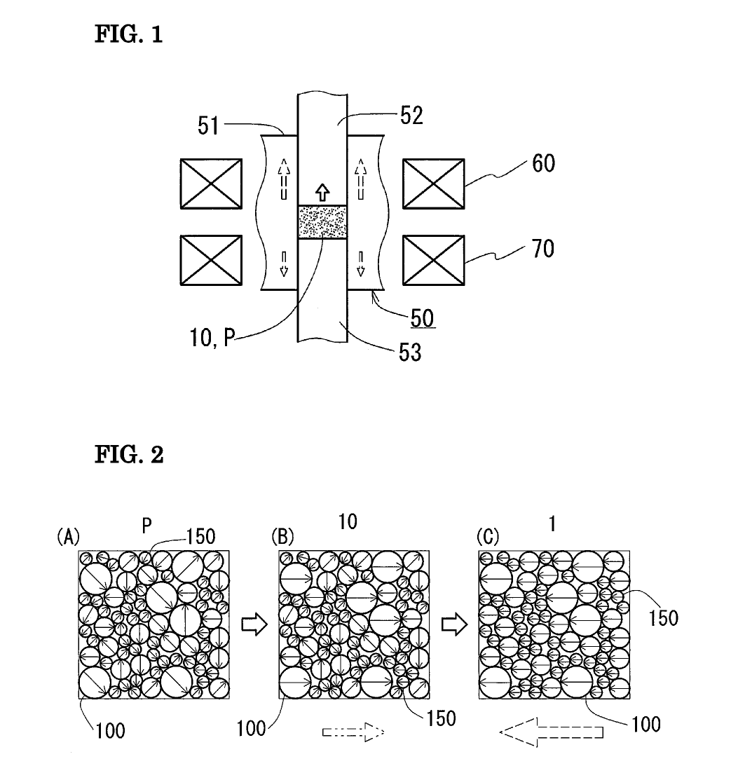

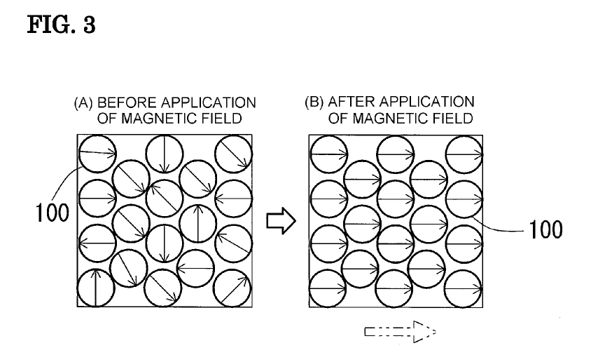

Next, there will be described a compacting mold for compacting and compressing the material powders, and magnets for applying a magnetic field to the compacts. In the tests, a normal conducting magnet with a normal conducting coil (here, a copper wire coil) was used for the application of a weak magnetic field, and a high-temperature superconducting magnet with a high-temperature superconducting coil was used for the application of a strong magnetic field. As illustrated in FIG. 1, the high-temperature superconducting coil 60 and the normal conducting coil 70 were arranged coaxially, and a compacting mold 50 was arranged at an inner periphery of these coils 60, 70. The compacting mold 50 included a die 51 having a throughhole, a columnar lower punch 53 that had been inserted into the die 51, and an upper punch 52 that was arranged opposite to the lower punch 53 and was configured to compact and compress the material powder P in cooperation with the lower punch 53. The die 51 and the lower punch 53 defined a compacting space, in which the material powder P was to be filled and be compacted and compressed by the upper punch 52 and the lower punch 53. During this process, magnetic fields were formable by appropriate excitation of the respective coils 60, 70, thus applying magnetic fields to a compact 10 in the compacting space.

A direction is determined beforehand in which particles forming the final green compact are to be oriented. The coils 60, 70 are arranged such that the coils 60, 70 apply magnetic fields in directions at desired solid angles to the desired orientation direction. For example, when the coils 60, 70 are arranged coaxially as illustrated in FIG. 1, magnetic fields may be applied in opposite directions by exciting the coils 60, 70 by current flowing in opposite directions. (In the figure, the broken line arrow and the two-dot chain line arrow indicate exemplary directions in which a magnetic field is applied.) That is, in this case, the magnetic field produced by the superconducting coil 60 can be applied in a direction at a solid angle of 180° to the direction in which a magnetic field is applied by the normal conducting coil 70.

Each of the material powders was filled into the compacting mold (compacting space: 10 mm diameter) and was compacted and compressed while controlling the pressure such that the packing density would be 1.05 to 1.2 times the bulk density. Thereafter, a (weak) magnetic field of 1.5 T was applied with the normal conducting coil. Here, the magnetic field was excited to 1.5 T in 10 seconds (excitation rate: 0.15 T/sec). This magnetic field was applied in a direction at a solid angle of 180° to the direction in which the final green compact was to be oriented.

A magnetic field was excited at an excitation rate described in Table II to a strength described in “Superconducting coil I” in Table II. Under the application of this magnetic field by the high-temperature superconducting coil, the compact subjected to the weak magnetic field was compacted and compressed while controlling the pressure such that the packing density would be above 1.2 and not more than 1.45 times the bulk density. Sample No. 35 was difficult to excite with the superconducting coil.

This magnetic field produced by the high-temperature superconducting coil was applied in a direction at a solid angle described in Table II to the direction in which the magnetic field had been applied by the normal conducting coil. That is, the solid angle 180° indicates that the sample was subjected to a magnetic field produced by the high-temperature superconducting coil in a direction opposite to the direction in which a magnetic field had been applied by the normal conducting coil, namely, the magnetic field was applied by the high-temperature superconducting coil in a direction in which the final green compact was to be oriented. The solid angle 0° indicates that the sample was subjected to a magnetic field produced by the high-temperature superconducting coil in the same direction as the direction in which a magnetic field had been applied by the normal conducting coil. In the latter case, the magnetic fields were applied to the sample by the normal conducting coil and the high-temperature superconducting coil both in the direction in which orientation was desired. For solid angles from above 0° to below 180°, the position of the normal conducting coil was shifted from the position illustrated in FIG. 1 so as to obtain the desired solid angle. The weak magnetic field was demagnetized by de-energizing the normal conducting coil after the excitation of the high-temperature superconducting coil was initiated.

In the tests, further, the magnetic field in “Superconducting coil I” was excited to a strength in “Superconducting coil II” described in Table II at an excitation rate described in Table II, and the compact subjected to the application of the magnetic field in “Superconducting coil I” was compacted and compressed under the application of the magnetic field produced by the high-temperature superconducting coil while controlling the pressure such that the packing density would be above 1.45 times the bulk density and not more than 66% the true density. The direction of the magnetic field applied was the same as that in Superconducting coil I. Through these steps, a green compact 1 (FIG. 2(C)) is obtained. The sizes of particles forming the green compact were confirmed to be substantially consistent with the particle size distribution of the material powder.

The obtained green compacts were each analyzed to determine the degree of crystal orientation. The results are described in Table II. The degree of crystal orientation was measured in the following manner. The measurement plane was a plane of the green compact extending in a direction perpendicular to the direction in which a magnetic field had been applied by the superconducting coil. (Here, the plane was perpendicular to the compacting direction and had been in contact with the upper or lower punch.) With respect to the measurement plane, pole figure analysis was carried out according to X-ray diffractometry. Diffraction spots of (006) planes were measured at which the solid angle became within 3° to the direction of the magnetic field application by the superconducting coil. The degree of crystal orientation was obtained by determining the proportion of such diffraction spots of (006) planes relative to the diffraction spots on the entirety of the measurement plane. The degree of crystal orientation was not studied for the sample No. 35 due to failed excitation.

TABLE II

| | | | | | Weak magnetic | |
|---|---|---|---|---|---|---|
| | | Strong magnetic field | | | field-strong | Degree of crystal |
| | Weak magnetic | Superconducting | Superconducting | Superconducting | magnetic field | orientation in |
| Sample | Copper wire coil | coil I | coil II | excitation rate | solid angle | green compact |
| No. | Magnetic field (T) | Magnetic field (T) | Magnetic field (T) | T/sec | ° | % |
| 1 | 1.5 | 3.5 | 5.5 | 0.1 | 180 | 95 |
| 2 | 1.5 | 3.5 | 5.5 | 0.1 | 180 | 96 |
| 3 | 1.5 | 3.5 | 5.5 | 0.1 | 180 | 96 |
| 4 | 1.5 | 3.5 | 5.5 | 0.1 | 180 | 97 |
| 5 | 1.5 | 3.5 | 5.5 | 0.1 | 180 | 97 |
| 6 | 1.5 | 3.5 | 5.5 | 0.1 | 180 | 97 |
| 7 | 1.5 | 3.5 | 5.5 | 0.1 | 180 | 98 |
| 8 | 1.5 | 1.5 | 5.5 | 0.1 | 180 | 89 |
| 9 | 1.5 | 2 | 5.5 | 0.1 | 180 | 90 |
| 10 | 1.5 | 2.5 | 5.5 | 0.1 | 180 | 92 |
| 11 | 1.5 | 3 | 5.5 | 0.1 | 180 | 95 |
| 12 | 1.5 | 4 | 5.5 | 0.1 | 180 | 96 |
| 13 | 1.5 | 4.5 | 5.5 | 0.1 | 180 | 97 |
| 14 | 1.5 | 3.5 | 4 | 0.1 | 180 | 87 |
| 15 | 1.5 | 3.5 | 4.5 | 0.1 | 180 | 91 |
| 16 | 1.5 | 3 | 5 | 0.1 | 180 | 95 |
| 17 | 1.5 | 3.5 | 5 | 0.1 | 180 | 96 |
| 18 | 1.5 | 3.5 | 6 | 0.1 | 180 | 97 |
| 19 | 1.5 | 3.5 | 6.5 | 0.1 | 180 | 97 |
| 20 | 1.5 | 3.5 | 7 | 0.1 | 180 | 98 |
| 21 | 1.5 | 3.5 | 5.5 | 0.1 | 0 | 84 |
| 22 | 1.5 | 3.5 | 5.5 | 0.1 | 40 | 87 |
| 23 | 1.5 | 3.5 | 5.5 | 0.1 | 80 | 93 |
| 24 | 1.5 | 3 | 5 | 0.1 | 90 | 95 |
| 25 | 1.5 | 3.5 | 5.5 | 0.1 | 90 | 96 |
| 26 | 1.5 | 3.5 | 5.5 | 0.1 | 100 | 95 |
| 27 | 1.5 | 3.5 | 5.5 | 0.1 | 140 | 96 |
| 28 | 1.5 | 3 | 5 | 0.001 | 180 | 90 |
| 29 | 1.5 | 3 | 5 | 0.002 | 180 | 91 |
| 30 | 1.5 | 3 | 5 | 0.005 | 180 | 93 |
| 31 | 1.5 | 3 | 5 | 0.01 | 180 | 95 |
| 32 | 1.5 | 3 | 5 | 0.05 | 180 | 96 |
| 33 | 1.5 | 3 | 5 | 0.1 | 180 | 95 |
| 34 | 1.5 | 3 | 5 | 0.15 | 180 | 97 |
| 35 | 1.5 | 3 | 5 | 0.20 | Excitation | — |
| 36 | 1.5 | — | 5 | Pulse | 180 | 92 |

The green compacts were sintered under vacuum at 1050° C. for 3 hours and aged at 650° C. for 5 hours to give sintered bodies. The sintered bodies were analyzed to determine the degree of crystal orientation, the residual flux Br (T) and the coercive force Hc (MA/m). The results are described in Table III. The degree of crystal orientation of the sintered bodies was measured in the same manner as for the green compacts.

To determine the residual flux Br and the coercive force Hc, the sintered bodies were magnetized in the same direction as the direction in which a magnetic field had been applied by the high-temperature superconducting coil, and the demagnetization curve obtained after the magnetization was analyzed.

TABLE III

| | Degree of crystal | | |
|---|---|---|---|
| | orientation in sintered | | |
| Sample | compact | Residual flux (Br) | Coercive force (Hc) |
| No. | % | T | MA/m |
| 1 | 95 | 1.47 | 0.77 |
| 2 | 96 | 1.47 | 0.79 |
| 3 | 96 | 1.48 | 0.79 |
| 4 | 97 | 1.48 | 0.79 |
| 5 | 98 | 1.49 | 0.80 |
| 6 | 98 | 1.49 | 0.81 |
| 7 | 99 | 1.50 | 0.83 |
| 8 | 90 | 1.35 | 0.74 |
| 9 | 90 | 1.36 | 0.75 |
| 10 | 92 | 1.38 | 0.77 |
| 11 | 96 | 1.46 | 0.79 |
| 12 | 96 | 1.47 | 0.80 |
| 13 | 98 | 1.49 | 0.82 |
| 14 | 87 | 1.34 | 0.71 |
| 15 | 91 | 1.36 | 0.72 |
| 16 | 96 | 1.46 | 0.77 |
| 17 | 96 | 1.47 | 0.78 |
| 18 | 98 | 1.48 | 0.77 |
| 19 | 97 | 1.48 | 0.79 |
| 20 | 99 | 1.49 | 0.78 |
| 21 | 86 | 1.31 | 0.73 |
| 22 | 87 | 1.33 | 0.74 |
| 23 | 93 | 1.38 | 0.74 |
| 24 | 96 | 1.46 | 0.79 |
| 25 | 96 | 1.48 | 0.81 |
| 26 | 96 | 1.48 | 0.80 |
| 27 | 96 | 1.47 | 0.80 |
| 28 | 90 | 1.35 | 0.73 |
| 29 | 91 | 1.35 | 0.76 |
| 30 | 93 | 1.39 | 0.74 |
| 31 | 95 | 1.46 | 0.79 |
| 32 | 96 | 1.48 | 0.78 |
| 33 | 95 | 1.47 | 0.79 |
| 34 | 97 | 1.49 | 0.81 |
| 35 | — | — | — |
| 36 | 92 | 1.36 | 0.77 |

As illustrated in Table II, the obtained green compacts exhibited excellent orientation even in the case where the material powder contained 15 mass % or more of fine particles having a particle diameter of not more than 2 μm. This result was achieved by the specific production method in which a weak magnetic field of 1 T to 2 T was applied in a direction at a solid angle of 90° to 180° to the desired orientation direction, and thereafter a strong magnetic field of not less than 3 T was excited at a high excitation rate of 0.01 T/sec to 0.15 T/sec using a superconducting coil, in particular a high-temperature superconducting coil, and was applied in the desired orientation direction. The reasons why this result was obtained are probably as follows. As illustrated in FIG. 2(A), the crystal orientation of particles is random in the material powder P before the application of a magnetic field. In FIG. 2, the arrows in the particles indicate the directions of magnetization easy axis. When a weak magnetic field is applied to the compact 10 having undergone the prescribed compacting and compression, coarse particles 100 are rotated and oriented in the direction based on the direction of this magnetic field application as illustrated in FIG. 2(B). However, fine particles 150 are not rotated sufficiently by the application of this magnetic field. A strong magnetic field is excited at high speed and is applied to the compact 10 in the specific direction different from that of the weak magnetic field (in the opposite direction in FIG. 2). Consequently, as illustrated in FIG. 2(C), the fine particles 150 are rotated together with the coarse particles 100 and are probably oriented in the direction based on the direction of this magnetic field application. In particular, it has been illustrated that the orientation of the compacts can be enhanced with increasing magnitude of the magnetic field applied by the superconducting coil. It has been further illustrated that a high-temperature superconducting coil capable of high-speed excitation and of applying a strong magnetic field can be suitably utilized in the production of green compacts with excellent orientation.

From Table III, the highly oriented green compacts which contained the above fine particles and were obtained by the aforementioned specific production method have been illustrated to substantially maintain the orientation after being sintered. The sintered bodies from the green compacts have been shown to have excellent magnetic properties, and exhibited magnetic properties comparable to those of sintered bodies (samples Nos. 6 and 7) from material powder containing a large amount of relatively coarse particles with diameters exceeding 2 μm.

It has been illustrated that in the case where the solid angle between the directions of magnetic fields applied by the normal conducting magnet and the superconducting magnet was 0° (sample No. 21), namely, in the case where a magnetic field was applied several times in the same direction, poor orientation resulted in spite of the magnetic field being applied in the direction in which the orientation was desired. The reason for this result is probably because fine particles with a diameter of not more than 2 μm had not been oriented sufficiently. A normal conducting pulse coil (sample No. 36) has been demonstrated to give lower orientation than does a superconducting coil, in particular a high-temperature superconducting coil. The reason for this fact is probably because the excitation rate was so high that the application of a magnetic field under effective compacting was not realized and consequently the particles were overrotated and were oriented randomly to fail to achieve good orientation.

The present invention is not limited to the embodiments described hereinabove, and appropriate modifications are possible without departing from the scope of the invention. For example, the composition of material powder, the shape and size of compacts, the excitation rate, the sintering conditions and other conditions may be changed appropriately.

### INDUSTRIAL APPLICABILITY

The sintered bodies according to the present invention may be suitably utilized as permanent magnets, for example, as permanent magnets used in various motors, in particular high-speed motors incorporated in devices such as hybrid electric vehicles (HEV) and hard disk drives (HDD). The magnetic green compacts of the invention may be suitably used as materials for the inventive sintered bodies. The inventive method for producing magnetic green compacts can be suitably used for the production of green compacts as materials for rare earth sintered magnets exhibiting a high degree of crystal orientation and excellent magnetic properties. Further, the inventive method for producing magnetic green compacts may be suitably used also for the production of (hard) ferrite magnets such as Sr—Fe—O, Ba—Fe—O, La—Sr—Fe—Co—0 and La—Ca—Fe—Co—O.

### REFERENCE SIGNS LIST

1 GREEN COMPACT
10 COMPACT
50 COMPACTING MOLD
51 DIE
52 UPPER PUNCH
53 LOWER PUNCH
60 HIGH-TEMPERATURE SUPERCONDUCTING COIL
70 NORMAL CONDUCTING COIL
P MATERIAL POWDER
100 COARSE PARTICLES
150 FINE PARTICLES

1. A magnetic green compact used as a material for a sintered magnet and comprising powder including a rare earth alloy containing a rare earth and iron,
the powder containing 15 mass % to 100 mass % of fine particles with a particle diameter of not more than 2 μm,
the green compact having a degree of crystal orientation of not less than 95%.

2. A method for producing magnetic green compacts as materials for sintered magnets using powder including a rare earth alloy containing a rare earth and iron, the method comprising:
a preparation step of providing material powder including the rare earth alloy and containing 15 mass % to 100 mass % of fine particles with a particle diameter of not more than 2 μm; and
a compacting step of filling the material powder into a compacting mold, compacting and compressing the material powder, and applying a magnetic field to form a green compact;
the compacting step comprising:
a light compacting step of compacting and compressing the material powder filled in the compacting mold to fabricate a powder compact having a packing density that is 1.05 to 1.2 times the bulk density;
a weak magnetic field application step of applying a weak magnetic field of 1 T to 2 T to the powder compact; and
a strong magnetic field application step of increasing the magnetic field strength to not less than 3 T at an excitation rate of 0.01 T/sec to 0.15 T/sec, and applying the strong magnetic field of not less than 3 T to the compact having undergone the weak magnetic field application step;
the weak magnetic field being applied in a direction at a solid angle of 90° to 180° to a desired direction in which crystals of particles forming the green compact are to be oriented;
the strong magnetic field being applied in the desired orientation direction using a superconducting coil.

3. The method for producing magnetic green compacts according to claim 2, wherein the strong magnetic field application step is performed in such a manner that the magnetic field strength is increased to not less than 3 T at an excitation rate of 0.01 T/sec to 0.15 T/sec and, after the strength reaches 3 T or above, the compact having undergone the weak magnetic field application step is further compacted and compressed under the application of the strong magnetic field of not less than 3 T so as to increase the packing density to above 1.2 times the bulk density.

4. The method for producing magnetic green compacts according to claim 3, wherein the strong magnetic field application step is performed in such a manner that the magnetic field strength is increased to not less than 3 T at an excitation rate of 0.01 T/sec to 0.15 T/sec and, after the strength reaches 3 T or above, the compact having undergone the weak magnetic field application step is further compacted and compressed under the application of the strong magnetic field of not less than 3 T so as to increase the packing density to above 1.2 and not more than 1.45 times the bulk density, and further
the magnetic field strength is increased to not less than 5 T at an excitation rate of 0.01 T/sec to 0.15 T/sec and, after the strength reaches 5 T or above, the compact is further compacted and compressed under the application of the strong magnetic field of not less than 5 T so as to obtain a packing density that is not less than 1.45 times the bulk density and not more than 66% the true density.

5. The method for producing magnetic green compacts according to claim 2, wherein the superconducting coil is a high-temperature superconducting coil.

6. A magnetic green compact obtained by the production method described in claims 2.

7. A sintered body obtained by sintering the magnetic green compact described in claim 1 or 6.
